(19) United States
(12) Patent Application Publication
(10) Pub. No.: US 2025/0323438 A1
(43) Pub. Date: Oct. 16, 2025

(54) HYBRID CONNECTOR

(71) Applicant: P-TWO INDUSTRIES INC., Taoyuan City (TW)

(72) Inventors: Chun-Wei CHANG, Taoyuan City (TW); Jeng-Yi YOU, Taoyuan City (TW); Wang-Kun TSAI, Taoyuan City (TW)

(21) Appl. No.: 18/938,508

(22) Filed: Nov. 6, 2024

(30) Foreign Application Priority Data
Apr. 12, 2024 (TW) 113113681

(51) Int. Cl. H01R 12/73; H01R 12/70; H01R 13/24; H01R 13/50

(52) U.S. Cl. CPC H01R 12/732; H01R 12/707; H01R 12/7088; H01R 13/2442; H01R 13/50

(57) ABSTRACT

A hybrid connector is disclosed, which comprises an insulating housing, a plurality of signal contacts and a plurality of power source contact pairs. The hybrid connector is mateable with a mating connector in a first direction, the mating connector including a plurality of plate-shaped power source contacts. Each power source contact pairs of the hybrid connector is composed of two power source contacts, which cooperate with each other to clamp one corresponding plate-shaped power source contact among the plurality of plate-shaped power source contacts therebetween and are in electrical contact with the one corresponding plate-shaped power source contact. In this way, the current passing through a single power source contact is reduced, thereby reducing heat generation and preventing heat accumulation.

### CROSS-REFERENCES TO RELATED APPLICATIONS

This application claims the benefit of priority to Taiwanese Patent Application No. 113113681 filed on Apr. 12, 2024, which is hereby incorporated by reference in its entirety.

### BACKGROUND OF THE INVENTION

### Field of the Invention

The present invention relates to a hybrid connector, and in particular to a hybrid connector capable of transmitting both signals and electric power.

### Descriptions of the Related Art

It is known to use a hybrid floating connector having signal contacts and power source contacts for transmission of signals and electric power. Such a hybrid floating connector has been disclosed, for example, in CN113690663A. However, in the hybrid floating connector disclosed in CN113690663A, the power source contact has a complicated shape which is not only difficult to manufacture but also has the problem of high temperature caused by heat accumulation.

On the other hand, the soldered portion of the power source contact disclosed in CN113690663A is positioned in the middle of the connector so that it very difficult to inspect the soldered state of the soldered portion of the power source contact when the connector is mounted on a circuit board.

### SUMMARY OF THE INVENTION

One object of the present invention is to provide a hybrid connector capable of reducing the current carried by the power source contact for prevention of heat accumulation.

Another object of the present invention is to provide a hybrid connector having a plurality of power source contacts which can be easily manufactured and which permit easy inspection of the soldered state.

In order to achieve the above and other objects, a two-piece power source contact is used in the hybrid connector according to the present invention.

According to one aspect of the present invention, a hybrid connector is provided, the hybrid connector comprising: an insulating housing, a plurality of signal contacts and a plurality of power source contact pairs, the plurality of signal contact and the plurality of power source contact pairs being held by the insulating housing, the hybrid connector being mateable with a mating connector in a first direction, the first signal contacts and the plurality of power source contact pairs being arranged in a second direction perpendicular to the first direction;
wherein the mating connector comprises a plurality of plate-like power source contact; and
each power source contact pair of the hybrid connector is provided for clamping one corresponding plate-like power source contact of the plurality of plate-like power source contacts therebetween and being placed into electric contact with said corresponding plate-like power source contact.

According to the hybrid connector of the present invention, each power source contact pair is composed of two power source contacts, each power source contact comprises a plate-like body portion, a power source contact arm and two soldered portions, the power source contact arm is formed on an upper edge of the plate-like body portion, the two soldered portions are formed on a lower edge of the plate-like body portion and extend in a third direction perpendicular to the first direction and the second direction so that at least a portion of each soldered portion is exposed from the insulating housing when the hybrid connector is mounted on a circuit board, the power source contact arms of each power source contact pair are bent to abut on each other or to be close to each other.

According to the hybrid connector of the present invention, a distant end of the power source contact arm is configured to be V-shaped or L-shaped.

According to the hybrid connector of the present invention, the distant end of the power source contact arm is formed with an elongated slit extending in a longitudinal direction of the power source contact arm for enhancing flexibility of the power source contact arm.

According to the hybrid connector of the present invention, the insulating housing includes a signal-side fitting portion and a plurality of power-source-side fitting portions, the plurality of power-source-side fitting portions being arranged at two sides of the signal-side fitting portion in the second direction.

According to the hybrid connector of the present invention, each power-source-side fitting portion is provided for receiving a respective power source contact pair.

According to the hybrid connector of the present invention, each signal contact includes a connection terminal portion extending in a third direction perpendicular to the first direction and the second direction so that at least a portion of the connection terminal portion is exposed from the insulating housing when the hybrid connector is mounted on a circuit board.

According to the hybrid connector of the present invention, each signal contact further comprises a held portion held by the insulating housing and a contact arm extending into the signal-side fitting portion.

According to the hybrid connector of the present invention, a side wall of the insulating housing adjacent to the signal-side fitting portion is formed with one or more cavity portions.

According to the hybrid connector of the present invention, an outer surface of the side wall of the insulating housing adjacent to the signal-side fitting portion is formed with a plurality of recess portions.

The above and other objects and advantages of the present invention will become apparent from the accompanying drawings and the following detailed description.

### BRIEF DESCRIPTION OF THE DRAWINGS

FIG. 1 is a perspective view of a board-to-board connector assembly according to the embodiment of the present invention.

FIG. 2 is a perspective view of the board-to-board connector assembly according to the embodiment of the present invention in an unmated state.

FIG. 3 is a perspective view of a first hybrid connector according to the embodiment of the present invention.

FIG. 4 is another perspective view of the first hybrid connector according to the embodiment of the present invention.

FIG. 5 is an exploded perspective view of the first hybrid connector according to the embodiment of the present invention.

FIG. 6 is a perspective view of an insulating housing of the first hybrid connector according to the embodiment of the present invention.

FIG. 7 is a perspective view of a signal contact of the first hybrid connector according to the embodiment of the present invention.

FIG. 8 is a perspective view of a power source contact of the first hybrid connector according to the embodiment of the present invention.

FIG. 9 is a front view of a power source contact pair of the first hybrid connector according to the embodiment of the present invention.

FIG. 10 is a perspective view of the first hybrid connector according to the embodiment of the present invention with a cover being mounted thereon.

FIG. 11 is a perspective view of a second hybrid connector according to the embodiment of the present invention.

FIG. 12 is an exploded perspective view of the second hybrid connector according to the embodiment of the present invention.

### DETAILED DESCRIPTION OF THE PREFERRED EMBODIMENT

The board-to-board connector assembly according to the embodiment of the present invention will be described with reference to the drawings. In the drawings, the same components or components with similar functions are designated by the same reference numerals. The drawings are not necessarily drawn to scale.

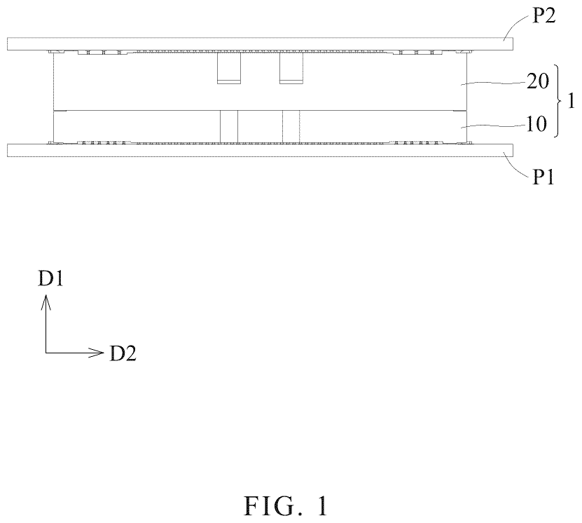

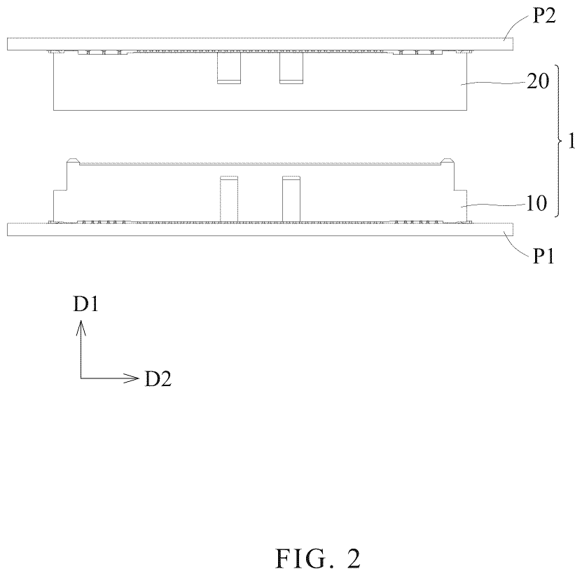

FIG. 1 is a perspective view of the board-to-board connector assembly according to the embodiment of the present invention. The board-to-board connector assembly is entirely designated by the reference numeral 1. The board-to-board connector assembly 1 comprises a first hybrid connector 10 and a second hybrid connector 20 serving as a mating connector for the first hybrid connector 10. Both of the first hybrid connector 10 and the second hybrid connector 20 are capable of transmitting signals and electric power. The first hybrid connector 10 is mounted on a first circuit board P1 by using surface mount technology (SMT), and the second hybrid connector 20 is mounted on a second circuit board P2 by using surface mount technology (SMT). The first hybrid connector 10 and the second hybrid connector 20 mate with each other in a first direction D1. In FIG. 1, the board-to-board connector assembly 1 is in a mated state. In FIG. 2, the board-to-board connector assembly 1 is in an unmated state. According to the present invention, the first hybrid connector 10 is embodied as a receptacle connector, and the second hybrid connector 20 is embodied as a plug connector.

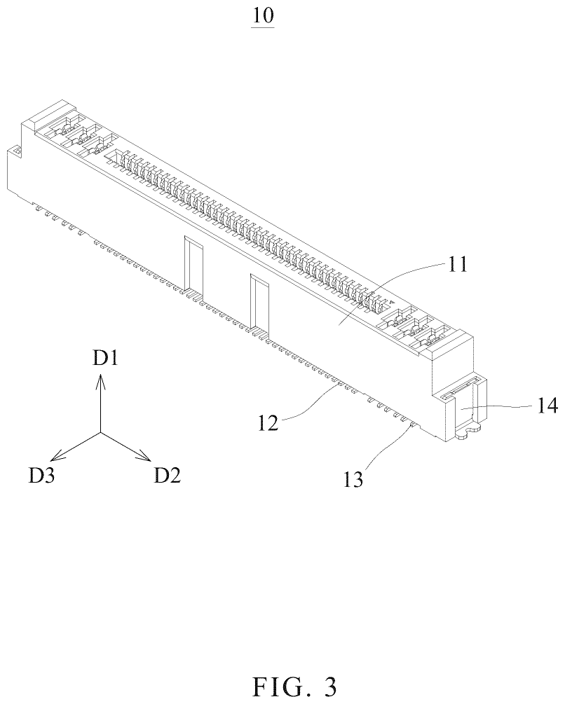

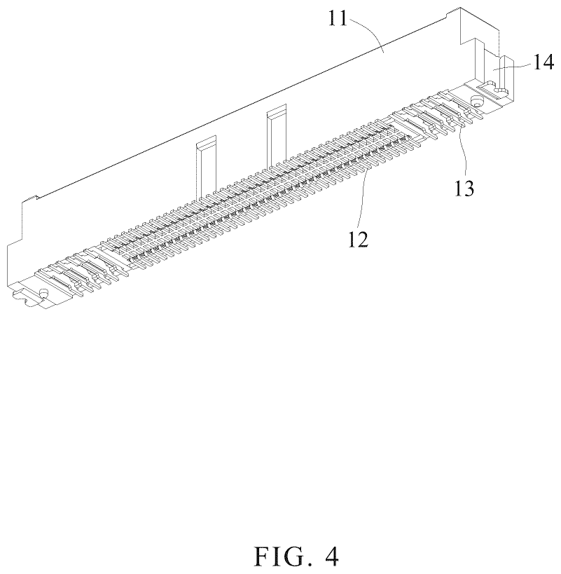

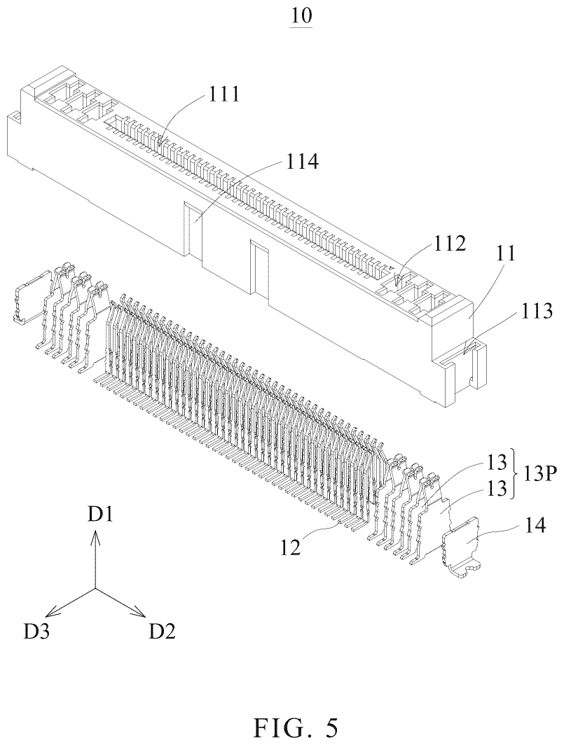

FIG. 3 is a perspective view of the first hybrid connector 10 according to the embodiment of the present invention. FIG. 4 is another perspective view of the first hybrid connector 10 according to the embodiment of the present invention. FIG. 5 is an exploded perspective view of the first hybrid connector 10 according to the embodiment of the present invention. The constituent elements of the first hybrid connector 10 are described with reference to FIGS. 3 to 5.

As shown in FIGS. 3 to 5, the first hybrid connector 10 includes an insulating housing 11, a plurality of signal contacts 12, a plurality of power source contacts 13 and two hold downs 14. The signal contacts 12 and the power source contacts 13 are held by the insulating housing 11. The signal contacts 12 are arranged in two rows along a second direction D2 perpendicular to the first direction D1. The power source contacts 13 are arranged along the second direction D2. Half of the power source contacts 13 are disposed on one side of the signal contacts 12 in the second direction D2, and the other half of the power source contacts 13 are disposed on the other side of the signal contacts 12 in the second direction D2. Each hold down 14 is inserted into a retaining slot 113 formed at a respective end of the insulating housing 11 in an interference fit manner. By soldering the soldered portions of the hold downs 14 to the solder pads of the circuit board, the first hybrid connector 10 can be firmly mounted to the circuit board.

The insulating housing 11 includes a signal-side fitting portion 111, three power-source-side fitting portions 112 located at one side of the signal-side fitting portion 111 and three power-source-side fitting portions 112 located at the other side of the signal-side fitting portion 111. The signal contacts 12 (particularly, the contact arms of the signal contacts 12) are arranged in the signal-side fitting portion 111. As shown in FIG. 5, every two power source contacts 13 are paired and thus form a power source contact pair 13P which is regarded as a two-piece power source contact. Each power-source-side fitting portion 112 receives a respective power source contact pair 13P, i.e. the paired two power source contacts 13.

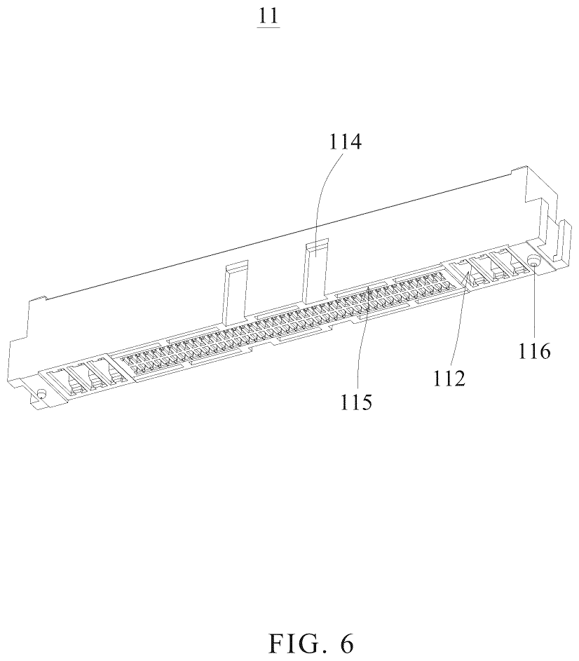

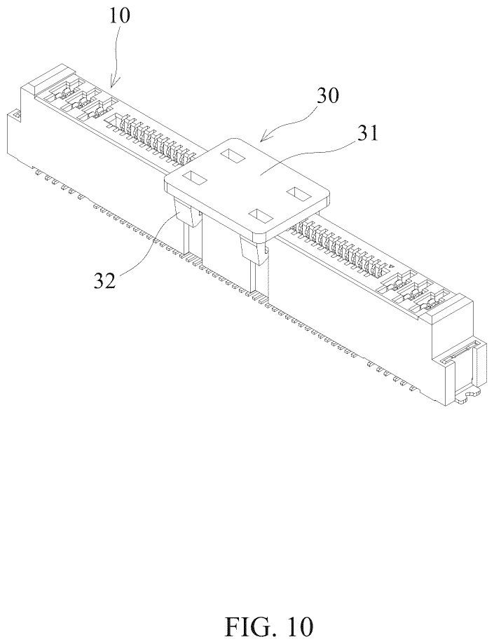

FIG. 6 is a perspective view of the insulating housing 11 of the first hybrid connector 10 according to the embodiment of the present invention. A plurality of recess portions 114 are formed on an outer surface of the side wall of the insulating housing 11 adjacent to the signal-side fitting portion 111. The recess portions 114 are provided to be engaged with the claws of the cover 30 (shown in FIG. 10). One or more cavity portions 115 are formed on the side wall of the insulating housing 11 adjacent to the signal-side fitting portion 111. In order to facilitate the formation of the insulating housing 11, the cavity portions 115 are opened on the bottom surface of the insulating housing 11. With aid of formation of the cavity portions 115, deformation caused by uneven shrinkage can be prevented.

As can be seen in FIG. 6, a positioning post 116 is formed on the bottom surface of the insulating housing 11. Before the first hybrid connector 10 is soldered to the circuit board by using surface mount technology (SMT), the first hybrid connector 10 can be temporarily positioned in place by use of the positioning post 116.

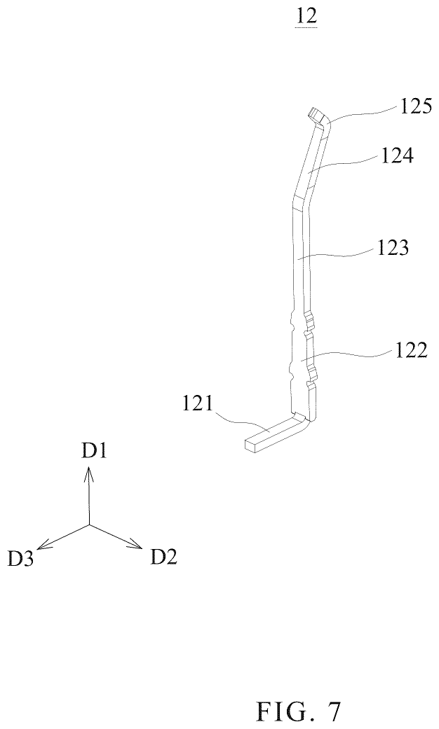

FIG. 7 is a perspective view of the signal contact 12 of the first hybrid connector 10 according to the embodiment of the present invention.

The signal contact 12 includes a connection terminal portion 121, a held portion 122, an extension portion 123, a contact arm 124 and a contact portion 125. The connection terminal portion 121 extends in a third direction D3 which is perpendicular to the first direction D1 and the second direction D2. The connection terminal portion 121 is to be soldered to the solder pads formed on the first circuit board P1 by using surface mount technology (SMT). When the first hybrid connector 10 is mounted on the first circuit board P1, at least a portion of the connection terminal portion 121 of the signal contact 12 is exposed from the insulating housing 11 for inspection of the soldered state of the connection terminal portion 121. The held portion 122 extends in the first direction D1 from the connection terminal portion 121. The held portion 122 is provided with a barb structure and is inserted into a signal contact holding hole formed in the insulating housing 11 in an interference fit manner. The extension portion 123 extends in the first direction D1 from the held portion 122. The contact arm 124 is inclined with respect to the extension portion 123 and extends into the signal-side fitting portion. The contact portion 125 is formed on the distant end of the contact arm 124 and configured to be V-shaped or L-shaped.

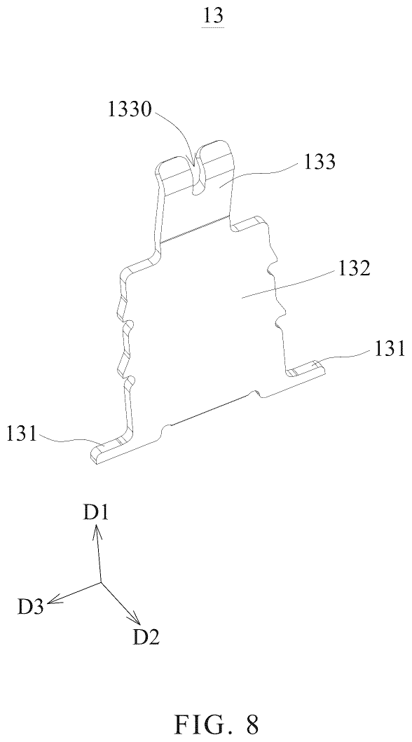

FIG. 8 is a perspective view of the power source contact 13 of the first hybrid connector 10 according to the embodiment of the present invention.

The power source contact 13 includes two soldered portions 131, a plate-like body portion 132 and a power source contact arm 133. The power source contact arm 133 is formed on an upper edge of the plate-like body portion 132. The soldered portions 131 are formed on a lower edge of the plate-like body portion 132 and extend in the third direction D3. When the first hybrid connector 10 is mounted on the first circuit board P1, at least a portion of each soldered portion 131 of the power source contact 13 is exposed from the insulating housing 11. The distant end of the power source contact arm 133 is configured to be V-shaped or L-shaped. The distant end of the power source contact arm 133 is formed with an elongated slit 1330 extending in a longitudinal direction of the power source contact arm 133 for enhancing flexibility of the power source contact arm 133.

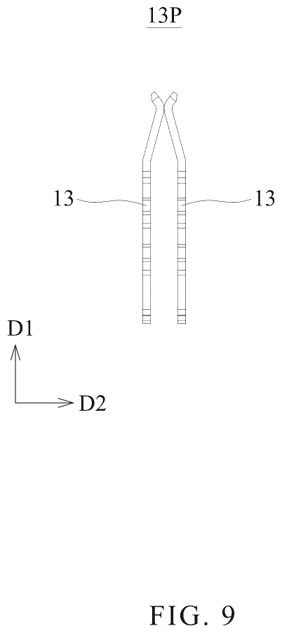

FIG. 9 is a front view of the power source contact pair 13P of the first hybrid connector 10 according to the embodiment of the present invention when viewed from the third direction D3. The power source contact arms of the power source contact pair 13P are bent to abut on each other so as to clamp a corresponding plate-shaped power source contact of the second hybrid connector 20 therebetween. It should be understood that the power source contact arms of the power source contact pair may not necessarily be configured to abut each other. The power source contact arms of the power source contact pair may be bent to be close to each other.

FIG. 10 is a perspective view of the first hybrid connector according to the embodiment of the present invention with the cover 30 being mounted thereon. The cover 30 has a body portion 31 and four claws 32. The claws 32 are formed on the bottom surface of the body portion 31 and extend downwardly. The body portion 31 of the cover 30 has a flat surface having an area sufficient to be sucked by a vacuum suction nozzle. The claws 32 are to be engaged with the recess portions 114 formed on the outer surface of the side wall of the insulating housing 11.

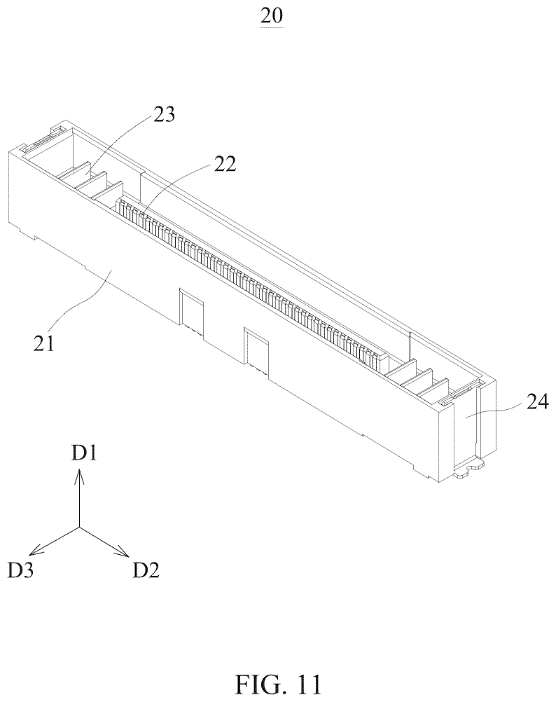

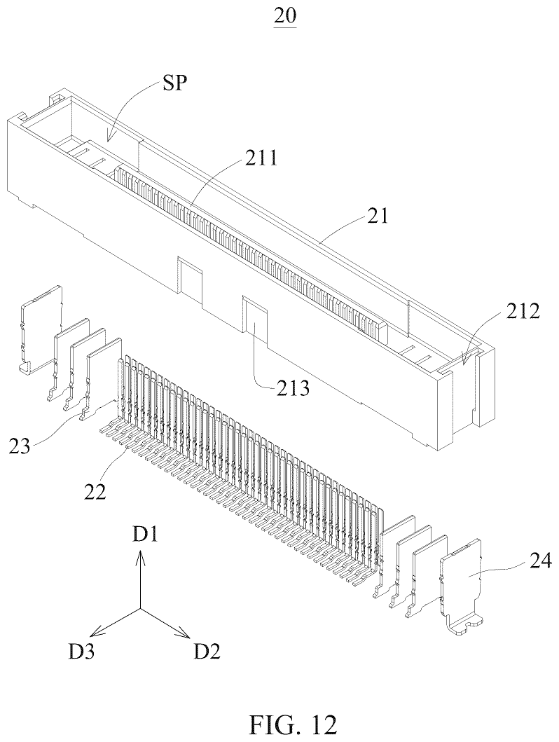

FIG. 11 is a perspective view of the second hybrid connector 20 according to the embodiment of the present invention. FIG. 12 is an exploded perspective view of the second hybrid connector 20 according to the embodiment of the present invention. The constituent elements of the second hybrid connector 20 are described with reference to FIGS. 11 and 12.

As shown in FIGS. 11 and 12, the second hybrid connector 20 includes an insulating housing 21, a plurality of signal contacts 22, a plurality of plate-shaped power source contacts 23 and two hold downs 24. The signal contacts 22 and the plate-shaped power source contacts 23 are held by the insulating housing 21. The signal contacts 22 are arranged in two rows along the second direction D2. The plate-like power source contacts 23 are arranged along the second direction D2. Half of the plate-shaped power source contacts 23 are arranged on one side of the signal contacts 22 in the second direction D2, and the other half of the plate-shaped power source contacts 23 are arranged on the other side of the signal contact 22 in the second direction D2. Each hold down 24 is inserted into retaining slot 212 formed at a respective end of the insulating housing 21 in an interference fit manner. The second hybrid connector 20 can be firmly mounted on the circuit board by soldering the soldered portions of the hold downs 24 to the solder pads of the circuit board.

As shown in FIG. 12, a receiving space SP is substantially defined by the side wall of the insulating housing 21, and a tongue 211 is formed in the receiving space SP. A contact portion of the signal contact 22 is positioned on the tongue 211. When the board-to-board connector assembly 1 according to the embodiment of the present invention is in the mated state, a part of the insulating housing 11 of the first hybrid connector 10 is inserted into the receiving space SP of the insulating housing 21 of the second hybrid connector 20. At that time, the tongue 211 of the insulating housing 21 of the second hybrid connector 20 is inserted into the signal-side fitting portion 111 of the insulating housing 11 of the first hybrid connector 10, so that the signal contacts 12 of the first hybrid connector 10 are in electrical contact with the signal contact 22 of the second hybrid connector 20. Each plate-shaped power source contact 23 is inserted between a respective power source contact pair 13P and is in electrical contact with the respective power source contact pair 13P.

A plurality of recess portions 213 are formed on the outer surface of the side wall of the insulating housing 21 so as to be engaged with a cover (not shown).

While this invention has been described in reference to preferred embodiments, it should be understood that numerous changes and modifications could be made within the spirit and scope of the inventive concepts described. Accordingly, it is intended that the invention not be limited to the disclosed embodiment, but that it have the full scope permitted by the language of the following claims.

What is claimed is:

1. A hybrid connector comprising: an insulating housing, a plurality of signal contacts and a plurality of power source contact pairs, the plurality of signal contact and the plurality of power source contact pairs being held by the insulating housing, the hybrid connector being mateable with a mating connector in a first direction, the first signal contacts and the plurality of power source contact pairs being arranged in a second direction perpendicular to the first direction;
wherein the mating connector comprises a plurality of plate-like power source contact; and
each power source contact pair of the hybrid connector is provided for clamping one corresponding plate-like power source contact of the plurality of plate-like power source contacts therebetween and being placed into electric contact with said corresponding plate-like power source contact.

2. The hybrid connector of claim 1, wherein each power source contact pair is composed of two power source contacts, each power source contact comprises a plate-like body portion, a power source contact arm and two soldered portions, the power source contact arm is formed on an upper edge of the plate-like body portion, the two soldered portions are formed on a lower edge of the plate-like body portion and extend in a third direction perpendicular to the first direction and the second direction so that at least a portion of each soldered portion is exposed from the insulating housing when the hybrid connector is mounted on a circuit board, the power source contact arms of each power source contact pair are bent to abut each other or to be close to each other.

3. The hybrid connector of claim 2, wherein a distant end of the power source contact arm is configured to be V-shaped or L-shaped.

4. The hybrid connector of claim 3, wherein the distant end of the power source contact arm is formed with an elongated slit extending in a longitudinal direction of the power source contact arm for enhancing flexibility of the power source contact arm.

5. The hybrid connector of claim 1, wherein the insulating housing includes a signal-side fitting portion and a plurality of power-source-side fitting portions, the plurality of power-source-side fitting portions being arranged at two sides of the signal-side fitting portion in the second direction.

6. The hybrid connector of claim 5, wherein each power-source-side fitting portion is provided for receiving a respective power source contact pair.

7. The hybrid connector of claim 6, wherein each signal contact includes a connection terminal portion extending in a third direction perpendicular to the first direction and the second direction so that at least a portion of the connection terminal portion is exposed from the insulating housing when the hybrid connector is mounted on a circuit board.

8. The hybrid connector of claim 7, wherein each signal contact further comprises a held portion held by the insulating housing and a contact arm extending into the signal-side fitting portion.

9. The hybrid connector of claim 5, wherein a side wall of the insulating housing adjacent to the signal-side fitting portion is formed with one or more cavity portions.

10. The hybrid connector of claim 5, wherein an outer surface of the side wall of the insulating housing adjacent to the signal-side fitting portion is formed with a plurality of recess portions.
